(19) United States
(12) Patent Application Publication
(10) Pub. No.: US 2012/0126156 A1
(43) Pub. Date: May 24, 2012

(54) APPARATUS AND METHOD FOR LOCKING A VALVE

(76) Inventor: Donnie Bennett, Zebulon, GA (US)

(21) Appl. No.: 13/360,766

(22) Filed: Jan. 29, 2012

(51) Int. Cl. F16K 35/00; B23P 19/00

(52) U.S. Cl. 251/90; 29/428

(57) ABSTRACT

The present apparatus is a novel locking apparatus and method for use with a shut-off valve. The housing of the locking apparatus is configured to receive at least a portion of the shut-off valve and secure it in a closed or off position. The housing of the locking device envelopes the shut-off valve and is secured in placed through the use of two screws. The screws have proprietary head shapes having a matching key. By using a housing which envelopes the shut-off valve and screws with proprietary head shapes, conventional methods to gain unauthorized access to the shut-off valve, such as lock picks, lock cutters, hammers, pry bars, and the like are ineffective.

### BACKGROUND OF THE INVENTION

1. Field of Invention

The present invention relates to security devices and methods for locking valves routinely utilized to regulate the flow of material. More specifically, the present invention relates to an apparatus and method having an integrated locking mechanism, wherein the present invention is positionable over at least a portion of a valve to prevent the unauthorized use thereof.

2. Description of the Related Art

Valves are routinely utilized in industrial, military, commercial and residential settings to regulate, direct and/or control the flow of material by opening, closing or partially obstructing various passageways. One of the most common materials is water. In modern society, there are a multitude of water-use applications including, for example, flushing toilets, washing clothes, washing dishes, bathing, drinking, cooking and landscaping. At the consumer residential level, main valves which regulate the flow of water into the home are of great significance. Typically, for those who do not use a well, water is acquired from a government entity, i.e. water department, which is responsible for providing clean, potable water. In general, a bill based on the user's consumption is typically sent to the consumer on a monthly basis. When the bill becomes delinquent, in order to protect their financial interest, the water department, or similar agency, will shut off the main valve at the water meter to stop the consumer from acquiring water until the bill is paid. In the prior-art method, this valve is held in the off position through the use of a lock secured to structures present about the exterior of the valve. More specifically, a main valve typically has a shoulder extending from a fixed portion of the valve and another shoulder extending from the rotatable portion of the valve, wherein when the valve is in the off position, through-holes in each of the shoulders align. The shackle of a pad lock can then be placed through said through-holes to lock the valve in the off position.

Once the valve associated with a water meter is secured in the off position through the use of a pad lock the water department has to worry about forced entry and surreptitious attacks by authorized individuals. Since a conventional pad lock is typically used to secure the valve in an off position, the consumer may be tempted to try various attack methods to remove the lock. It is not uncommon for those affected by a locked water valve to attempt and remove the lock through the use of lock cutters, screw drivers, pliers, pry bars or even a hammer. The less destructive methods of removal include the use of lock picks, bump keys, shims and lock cutters. When these methods are employed, a conventional pad lock is easily removed resulting in the theft of water and the destruction of property, the lock. When a more destructive method is employed such as the pry bar or hammer the valve itself may become damaged resulting in the water department being unable to lock the valve in the future. Further, the damage to the valve may be so severe that the water line begins to leak resulting in flooding. Once the water valve has been damaged, an expensive repair process must be initiated. This repair process typically includes the shut off of another valve upstream from the damaged one resulting in other consumers having their water shut off. The extraction and replacement of a damaged water valve is work reserved for skilled laborers and results in both unhappy customers and a significant expensive in the form of labor and material cost to the water department. As such it would be advantageous to a water department, or similar institution, if there was an apparatus and method by which a water valve might be secured in the off position and be resistant to tampering and various attacks which a prior art locking mechanism might succumb to.

### SUMMARY OF THE INVENTION

Accordingly, several representative objects and advantages of the present invention are:
(a) To provide a security device and method with an integrated locking mechanism that may be used to secure a valve against unauthorized operation.
(b) To provide a locking apparatus and method which discourages the use of conventional efforts used to remove prior art locking devices such as pad locks.
(c) To provide an apparatus and method which uses a non-conventional key to secure the locking mechanism into place that is resistant to conventional attacks used to remove the prior art locks.
(d) To provide an apparatus and method with a unique shape which resist attempts to use common gripping or destructive tools.
(e) To provide a method that places and secures a security device over a water valve and retains it in place through the use of an integrated locking mechanism.

In accordance with one embodiment of the present invention, provided is an apparatus which consist of a cylindrical housing having a portion of its interior removed and contoured to receive the top portion of the shut-off valve. The housing is constructed of a rigid, rust resistant material and fully encompasses the valve knob. The cylindrical shape of the housing is of sufficient size and has a smooth exterior which restricts the use of common gripping and destructive tools. The contoured interior of the cylindrical housing is of sufficient size to fully envelope the shut off valve knob and a portion of the fitting it is attached to. By fully enveloping the shutoff valve with a solid cylinder, such as is provided by the herein disclosed apparatus, tools such as pry bars cannot be effectively employed to break the locking mechanism thus mitigating and/or preventing damage to the shut off valve. The housing is secured in place through the use of two tensioning screws located on opposite sides of the housing. The tensioning screws have a head which has a unique external geometry that matches up with a key provided by the manufacturer. By using a proprietary head shape for the screw, conventional screw drivers may not be employed to remove the tensioning screws. Further, the two tensioning screws are threadedly secured to the housing in holes which are sunk into the exterior of the housing such that the head of the screw does not protrude past the exterior of the housing. The forgoing construction of the housing and locking mechanism prevents an unauthorized user from using conventional forced entry and surreptitious attacks to remove the housing and gain access to the water valve.

The foregoing it a broad outline of the significant features of the present invention, more pertinent and specific details of these features are discussed in the detailed description of the invention that follows. It should be understood by those skilled in the art that the disclosed preferred embodiment may be modified or used as a basis for designing other methods of constructing a similar device which is capable of fulfilling the same purpose. Still further objects and advantages will become apparent from a consideration of the ensuing description and drawings.

### DESCRIPTION OF THE DRAWINGS

The novel features believed to be characteristic of the invention, together with further advantages thereof, will be better understood from the following description considered in connection with the accompanying drawings in which a preferred embodiment of the present invention is illustrated by way of example.

FIG. 1 is a bottom perspective view of the apparatus for locking a valve;

FIG. 2 is a top perspective view of the apparatus for locking a valve;

FIG. 3 is a side perspective view of a water valve, the work piece;

FIG. 4 is a side perspective view of the apparatus for locking a valve secured about a water valve; and

FIG. 5 is a bottom perspective view of the apparatus for locking a valve secured about a water valve.

It is to be expressly understood, however, that the drawings are for the purpose of illustration and description only and are not intended to define the limits of the invention.

### DETAILED DESCRIPTION OF THE PREFERRED EMBODIMENT

In describing a preferred embodiment of the shut-off valve locking apparatus and method illustrated in drawings, specific terminology will be used for the sake of clarity. However, the invention is not intended to be limited to the specific terms so selected, and it is to be understood that each specific term includes all technical equivalents which operate in a similar manner to accomplish a similar purpose.

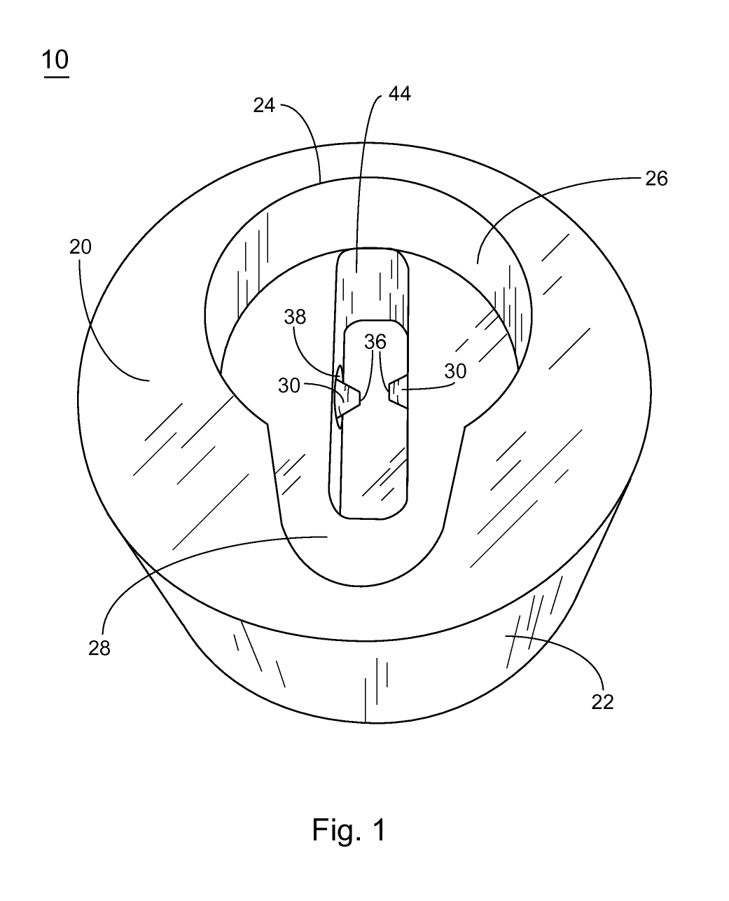

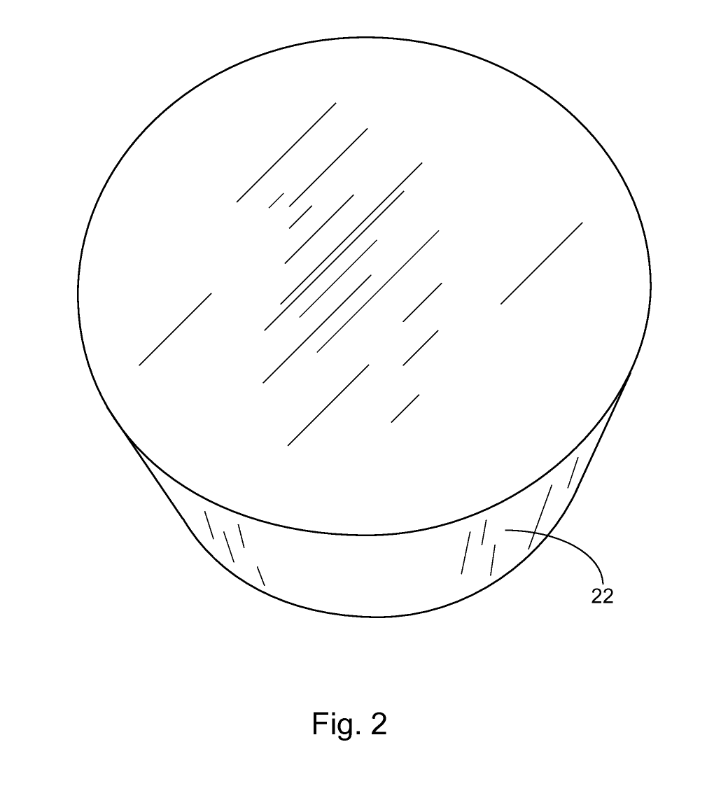

Turning now to the figures in which like reference characters indicate corresponding elements throughout the several views, there is shown a shut-off valve locking apparatus and method, generally designated by reference numeral 10, which consist of a cylindrical housing, generally designated by reference numeral 20, that serves as a security device and a set of screws, generally designated by reference numeral 30, which serve as a locking means to retain the housing 20 in position about a valve 50. As used herein, the word “bottom” corresponds to the receiving side of the shut-off valve locking apparatus 10 as shown in FIG. 1; “top” corresponds to the opposing side of the locking device 10 as shown in FIG. 2.

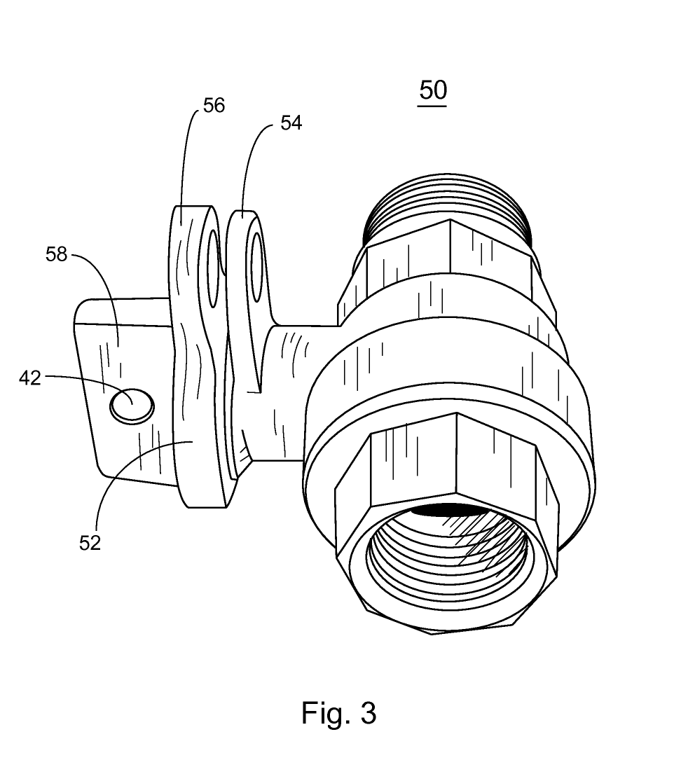

Shown in FIG. 1 is an illustration of the locking apparatus 10 showing the housing 20. The exterior 22 of the housing 20 is generally cylindrical in shape. The housing 20 is constructed, preferably from an aluminum alloy, but other materials such as high strength polymers, metal-polymer blends, and iron alloys could also be used. One side of the housing 20 has a void 24 which is shaped to receive a shut-off valve 50 when in its closed position, as shown in FIG. 3. The interior 24 of the housing 20 has been constructed to accommodate the various structural elements of a valve 50. The interior generally consist of an approximately circular shaped opening 26 which overlaps with an inlet 28 that has a generally ovular shape. Offset from the center and located approximately along the center line of the housing 20 is a generally rectangular slot 44. The generally cylindrical opening 26 is configured to receive the knob 52 of the shut off valve 50, with the top extension 58 of the knob 52 being secured within the slot 44 provided. The inlet 28 of the interior 24 is shaped to accommodate two protrusions (54, 56), one protrusion 54 is integral to the valve 50 and the other protrusion 56 is integral to the knob 52, when the knob 52 is in the closed position. The closed position of the knob 52 has the two protrusions (54, 56) occupying different but parallel planes.

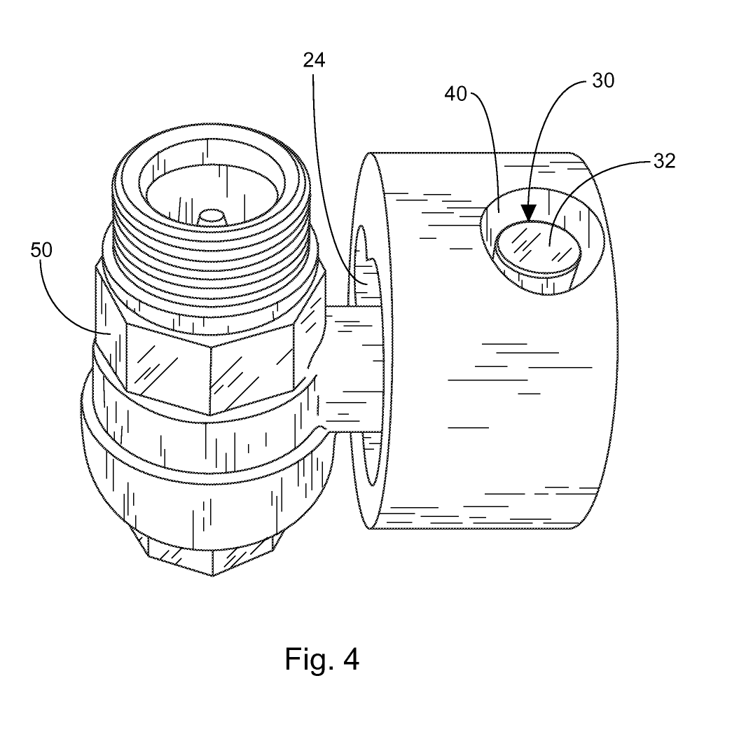

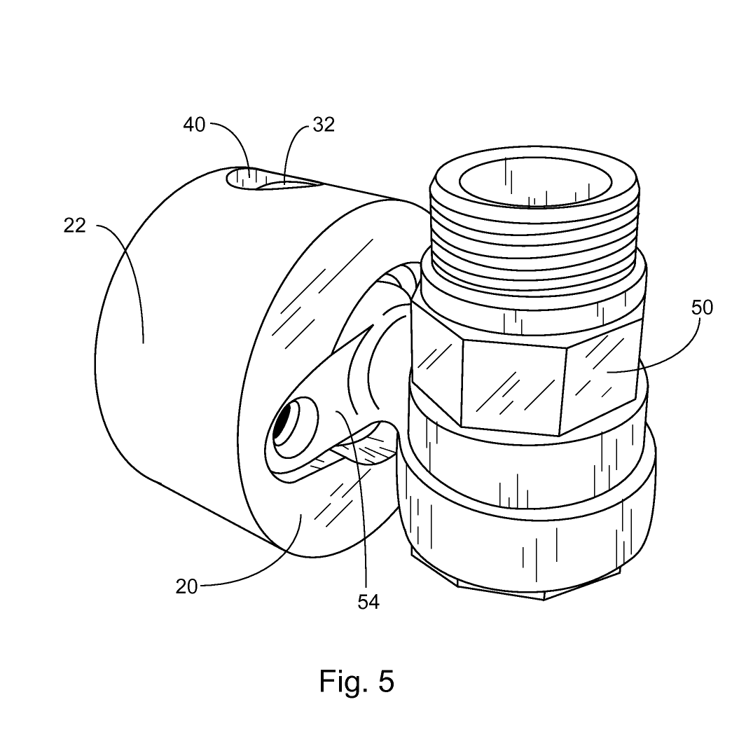

Located about the exterior 22 of the housing 20 are two bores 40, shown in FIG. 4 and FIG. 5. Recessed within the bores 40 are threaded openings 38 which extended into the interior 24, specifically the generally rectangular-shaped slot 44. One bore 40 is located on each side of the housing 20 and oriented such that the bores 40 and their threaded openings 38 aligned with each other. Two screws 30 are provided and consist of a head 32, a threaded shaft configured to threadedly engage with the threaded openings 38, and a tip 36. The head 32 of the screws 30 is generally ovular, but the exact shape is geometrically varied. By geometrically varying the shape of the screw 30 head 32 a unique key having a bore matching the specific shape of the screw 30 head 32 is provided to each customer. The head 32 of the screws 30 is designed to be received by a portion of a key which is used to rotate the screws 30 and thereby secure them in place. The shaft and tip 36 of the screw 36 are constructed to be received by the opening 42 present on the extension 58 of the valve 50 knob 52.

In practice the shut-off valve locking apparatus 10 is used as follows. A valve 50 (shown in FIG. 3), a water valve in this instance, is turned to the off position which aligns a stationary protrusion 56 with a separate protrusion 54 that is integral to the knob 52 of the shut off valve 50. Once so positioned the housing 20 is then oriented so that the interior 24 will receive the knob 52 of the valve 50 and its protrusions (54,56), as shown in FIGS. 4 & 5. Once the housing 20 is appropriately positioned one screw 30 is inserted into each bore 40 and threadedly engages with the threaded openings 38 provided therein. Once the threads are initially engaged a key can then be used to rotate the screws 30 until they are fully nested within the bores 40. When the screws 30 are fully seated at least the tip 36 of each is received through the opening 42 present on the knobs 52 extension 58 thereby securing the valve locking apparatus 10 into place, views of which are shown in FIGS. 4 & 5. When the screws 30 are fully seated the head 32 of a tensioning screw 30 does not protrude past the exterior 22 of the housing 20, as shown in FIG. 4.

The screws 30 used with the present invention may be constructed from any metal alloy which is appropriate for use as a screw. Additionally, in alternate embodiments, the threaded openings 38 present in the housing 20, which receives the screws 30, may be replaced with heli-coil inserts or equivalents to increase thread life or simply to strengthen the threads. This would also allow for the use of a durable polymer for the construction of the housing 20 by providing an insert which is appropriate for the reception of metal screws. Alternatively one of the two tensioning screws 30 could be omitted and the apparatus for locking a valve would still retain the essential functions described above.

The foregoing description and drawings should be considered illustrative only of the principles of the invention. The invention may be configured in a variety of shapes and sizes and is not limited by the dimensions of the preferred embodiment. Numerous applications of the present invention will readily occur to those skilled in the art. Therefore, it is not desired to limit the invention to the specific examples disclosed or the exact construction and operation shown and described. Rather, all suitable modifications and equivalents may be resorted to, falling within the scope of the invention. Accordingly, the scope of the invention should be determined not by the embodiments illustrated, but by the appended claims and their legal equivalents.

### CONCLUSION, RAMIFICATIONS, AND SCOPE

Accordingly, the reader will see that I have provided a shut-off valve locking apparatus 10 and method which in the preferred embodiment consists of a housing 20 constructed from a rigid material that uses two screws 30 to retain the housing 20 in place about a shut-off valve 50. The interior of the housing is configured to receive the knob 52 and the two protrusions (54, 56) found on commonly utilized water valves when oriented in the off position. The housing 20 is retained in placed through the use of two screws 30 which are constructed to be received through an opening 42 of the knobs 52 extension 58 thereby prevent the unauthorized removal of the shutoff valve locking apparatus 10. The herein proposed apparatus and method overcomes the weakness inherent in the prior-art valve security systems by providing a structure to secure the valve 50 in a locked positions that a) does not rely on a separate pad lock; b) is much more secure than prior-art methods thus reducing the likelihood of theft; and c) reduces the likelihood of damage to the valve in the event of an attempted forced removal thus resulting in fewer valves needing to be replaced and ultimately reducing the overall costs of operation.

1. A locking apparatus for a valve comprised of:
A housing having an exterior and an interior, said interior is configured to receive both a rotatable portion of a valve and a fixed portion of a valve;
A key which is configured to engage a screw head; and
At least one screw which is initially received through an opening in said housing, said at least one screw is adapted to be received through the exterior surface structure of said housing and at least a portion of the one screw is received by an opening located of said valve exterior.

2. The locking apparatus of claim 1, wherein said at least one screw has a head, said housing has a bore which receives the at least one screw and is configured such that the head of the screw, when fully seated within the bore, does not protrude from the exterior of said housing.

3. The locking apparatus of claim 1, wherein said housing has an exterior which is generally rounded.

4. A locking apparatus for a valve comprised of:
A housing having an exterior and an interior, said interior is configured to receive a portion of a valve to include at least one rotatable member;
A means by which said housing may be secured to said valve;
Whereas the housing is configured to receive a sufficient portion of a valve to thereby prevent its operation and said housing having a means by which it may be secured about the exterior of said valve which thereby prevents the removal of said housing.

5. The locking apparatus for a valve of claim 4, wherein said housing has at least one bore about its exterior which is configured to receive at least one screw which consist of a head, shaft and tip, said screw is threadedly received within said bore which is sufficiently deep that said head does not protrude from the exterior of said housing when the screw is fully seated.

6. The locking apparatus for a valve of claim 5, wherein said head of the screw is configured to be engaged by a key, said key receives said head of the screw within its interior, thereby engaging it and allowing a user to threadedly secure and unscrew said at least one screws.

7. The locking apparatus of claim 4, wherein the housing is secured about a valve by having its interior configured to receive a fixed portion of the valve and a rotatable portion of said valve, at least one screw is threadedly received by the housing and is received through an opening present on the exterior of said valve.

8. The locking apparatus of claim 7, wherein the valve has a rotatable knob with an extension protruding there from having an opening which is constructed to receive a portion of the at least one screw.

9. A method of securing a locking apparatus to a valve having an open and a closed position and further having a first protrusion extending from a fixed portion of the valve and a second protrusion extending from a rotatable portion of the valve and through-holes formed in each protrusion such that the through-holes align when the valve is in the off position, the method comprising the steps of:
rotating the rotatable portion of the valve to its closed position thereby aligning its protrusion with the protrusion located on the valve;
orient the housing of the locking apparatus to receive the valve knob and a portion of the valve, wherein the interior of the housing is configured to receive the valve knob, its extension and protrusion, and a portion of the valve to include at least its protrusion, said extension of the valve knob has an opening there through;
insert a screw into the two bores present about the exterior of said housing, wherein each bore has a recessed opening which continues through to the interior of the housing and is threaded and configured to engage with a portion of a screw, each screw is rotated until its head is fully nested within the bore resulting in a portion of said screw being received through an opening present on the extension of the valve knob.

10. The method of claim 9 further comprising the step of using a key to engage said head of said at least one screw for use in rotating said screw into the desired position.

11. The method of claim 10, wherein said head of said screw is formed having a quasi-circular shape with specific angular variations and wherein said key has a receiving portion that matches said shape of said screw head.
